(19) United States
(12) Patent Application Publication
(10) Pub. No.: US 2020/0388152 A1
(43) Pub. Date: Dec. 10, 2020

(54) VEHICLE PROXIMITY ALERT SYSTEM

(71) Applicant: Bradley Harris, Raleigh, NC (US)

(72) Inventor: Bradley Harris, Raleigh, NC (US)

(21) Appl. No.: 16/432,939

(22) Filed: Jun. 6, 2019

(51) Int. Cl. G08G 1/0967; G08G 1/0962; G08G 1/16; B60W 50/14

(52) U.S. Cl. CPC G08G 1/0967; G08G 1/09623; B60W 2050/143; G08G 1/166; B60W 50/14; G08G 1/164

(57) ABSTRACT

A vehicle proximity alert system including a plurality of field transmitters, a notification unit and a housing unit. Each field transmitter is located externally from the vehicle and broadcasts an encoded signal including identification information for determining an imminent corresponding road hazard or road warning. The notification unit includes an antenna for receiving the encoded signal, a receiver for decoding the encoded signal and determining the imminent corresponding road hazard or road warning associated with the encoded signal, an internal transmitter for broadcasting an encoded signal requesting assistance for the vehicle and a vehicle interface unit for communicating the corresponding road hazard or road warning to the operator of the vehicle. The housing unit encloses the notification unit. The housing unit includes a solar panel for providing power to the notification unit, and one or more apertures for mounting the housing unit on a fixed structure.

### FIELD OF THE INVENTION

Embodiments described herein generally relate to vehicle driving aids, and more particularly to a vehicle proximity alert system.

### BACKGROUND OF THE INVENTION

Driving can be highly precarious for drivers who are on the road consistently or for drivers having a regular commute to work. Driving aids can be helpful to drivers who have become complacent on their daily routes or for drivers traversing a new area. The driving aid can improve driver safety by forewarning the vehicle operator of approaching road hazards or road warnings. Hence, it is desirable to provide a proximity alert system which forewarns a vehicle operator of approaching impediments for enhanced safety.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of a vehicle proximity alert system according to an embodiment of the present disclosure.

### SUMMARY OF THE INVENTION

Exemplary embodiments disclosed herein describe a vehicle proximity alert system including a plurality of field transmitters, a notification unit and a housing unit. Each field transmitter is located externally from the vehicle and broadcasts an encoded signal including identification information for determining a corresponding road hazard or road warning. The notification unit includes an antenna for receiving the encoded signal, a receiver for decoding the encoded signal and determining the corresponding road hazard or road warning associated with the encoded signal, an internal transmitter for broadcasting an encoded signal requesting assistance for the vehicle and a vehicle interface unit for communicating the corresponding road hazard or road warning to the operator of the vehicle. The housing unit encloses the notification unit. The housing unit includes a solar panel for providing power to the notification unit, and one or more apertures for mounting the housing unit on a fixed structure.

In some exemplary embodiments, each field transmitter broadcasts an encoded signal at a different radio frequency.

In some exemplary embodiments, each hazard or warning is associated with a different radio frequency.

In some exemplary embodiments, the receiver determines the corresponding hazard or warning based on the radio frequency of the encoded signal.

In some exemplary embodiments, each field transmitter is located at a location of the hazard or the warning.

In some exemplary embodiments, the hazard or warning is at least one from the group comprising low bridge, school zone, a road crew, stop sign, new traffic pattern, traffic accident, road construction.

In some exemplary embodiments, each field transmitter is mounted on at least one item from the group comprising a bridge, a road construction site, a road sign, a tow truck, a post stuck in the ground, a controlled access point.

In some exemplary embodiments, the housing unit is mounted inside the vehicle.

Another exemplary embodiment disclosed herein describes a vehicle proximity alert device including an antenna for receiving an encoded signal from a plurality of field transmitters, wherein each encoded signal includes identification information for determining an imminent corresponding road hazard or road warning; a receiver for decoding the encoded signal and determining the imminent corresponding road hazard or road warning associated with the encoded signal; a vehicle interface unit for communicating the corresponding road hazard or road warning to the operator of the vehicle; and a housing unit which encloses the antenna, receiver and vehicle interface unit, the housing unit including a solar panel for providing power to the antenna, receiver and vehicle interface unit, and one or more apertures for mounting the housing unit on a fixed structure.

### DETAILED DESCRIPTION

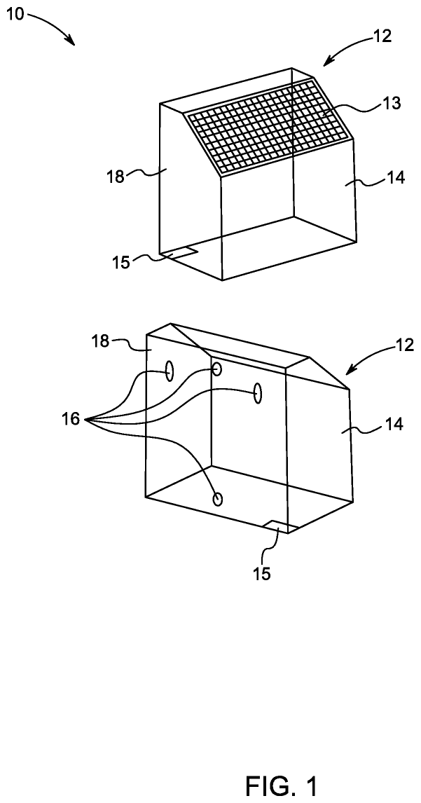

The present disclosure relates to a vehicle proximity alert system (“the system”). The system aids a driver or equipment (e.g., a self-driving vehicle) in driving safely by warning them of imminent roads hazards and/or road warnings, such as, for example, road crews, broken traffic lights, construction, low bridges, school zones, a new stop sign, road hazards, accidents, etc. As illustrated in FIG. 1, the system 10 includes a notification unit 12, a housing unit 18, and a plurality of field transmitters (not shown).

The plurality of field transmitters are each associated with a road hazard or road warning. Each field transmitter is located at an external location remote from the notification unit, and more particularly at a remote location directly at or very close to a corresponding hazard or warning. For example, a field transmitter associated with a low bridge may be mounted directly to the bridge. In the case of a warning indicated by a road sign, such as, for example, “school zone”, the field transmitter may be mounted directly to the road sign.

In other scenarios, such as, road hazards or construction, the field transmitter may be mounted on a post that can be stuck in the ground near the road hazard or road construction. The field transmitters may be mounted to department of transportation trucks, tow trucks or any other suitable item or place where information regarding approaching hazards or warnings could be delivered to the operator of a vehicle to allow them to make an informed safe driving decision. Moreover, in another exemplary embodiment, the field transmitter may be a remote mobile transmitter that is located in a mobile phone.

Each field transmitter is programmable and may be programmed to broadcast a wide range of encoded signals that the receiver in the notification unit can decode and determine a corresponding road hazard or road warning. The encoded signals each include identification information for determining an imminent corresponding hazard or warning. The encoded signals may be encoded using any suitable encoding method, such as, for example, transmitting the signal at a particular radio frequency designated for a corresponding hazard or warning. The field transmitters may be powered by a tiny rechargeable solar powered battery or by any other suitable means, including a hard wired power line. The field transmitters are portable and are configured to be easily attached to a sign, emergency vehicle, low bridge or any other hazard site.

The notification unit 12 includes an antenna (not shown) for receiving the encoded signals broadcasted from the field transmitters, a receiver 14 for decoding the encoded signals and determining an imminent corresponding road hazard or road warning associated with each received encoded signal, an internal transmitter 14 for broadcasting an emergency signal requesting assistance for the vehicle, a vehicle interface unit for communicating the corresponding road hazard or road warning to the operator of the vehicle, and a hard wiring unit 15 for hard wiring the notification unit to power lines.

The antenna receives an encoded signal from a field transmitter when the receiver 14 is within a certain distance of the field transmitter. This allows the receiver to decode the encoded signal and initiate a warning to the operator through the vehicle interface unit in advance of the vehicle reaching the hazard or warning. This advance warning provides the operator of the vehicle time to react safely to the hazard or warning. The receiver may decode the encoded signal using any suitable decoding method, such as, for example, decoding the radio frequency in which the encoded signal was transmitted and determining a corresponding hazard or warning from the transmitted radio frequency.

The internal transmitter 14 broadcasts an emergency signal when the operator of the vehicle activates an emergency button inside the vehicle. If the operator is involved in an accident, or is undergoing medical/health issues, the emergency button allows the operator to signal for help to surrounding vehicles and to a first responder that may be set up with the system for emergencies. The receiver 14 is also able to receive emergency signals broadcasts from other vehicles.

The vehicle interface unit notifies the operator of the hazard or warning. The vehicle interface unit may include a display and/or a sound mechanism. When the receiver 14 decodes the encoded signal, a message conveying the corresponding warning may be displayed on the display of the vehicle interface unit or a noise may be activated by the sound mechanism. The noise may include speech.

The housing unit 18 encloses the notification unit 12 and includes at least one solar panel 13 for providing power to the notification unit. Further, the housing unit includes one or more apertures 16 for mounting the housing unit on a fixed structure, such as, for example, to a dash board in a vehicle.

In another exemplary embodiment, the housing unit is installed in the dash board of a vehicle by the vehicle manufacturer.

Another exemplary embodiment of the present disclosure includes a vehicle proximity alert device including an antenna for receiving an antenna for receiving an encoded signal from a plurality of field transmitters, wherein each encoded signal includes identification information for determining an imminent corresponding road hazard or road warning; a receiver for decoding the encoded signal and determining the imminent corresponding road hazard or road warning associated with the encoded signal; a vehicle interface unit for communicating the corresponding road hazard or road warning to the operator of the vehicle; and a housing unit which encloses the antenna, receiver and vehicle interface unit, the housing unit including a solar panel for providing power to the antenna, receiver and vehicle interface unit, and one or more apertures for mounting the housing unit on a fixed structure.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A vehicle proximity alert system comprising:
a plurality of field transmitters, each field transmitter is located externally from the vehicle, and wherein each field transmitter broadcasts an encoded signal including identification information for determining a corresponding hazard or warning;
a notification unit including an antenna for receiving the encoded signal, a receiver for decoding the encoded signal and determining a corresponding hazard or warning associated with the encoded signal, an internal transmitter for broadcasting an emergency signal requesting assistance for the vehicle and a vehicle interface unit for communicating the corresponding hazard or warning to the operator of the vehicle; and
a housing unit which encloses the notification unit, the housing unit including a solar panel for providing power to the notification unit, and one or more apertures for mounting the housing unit on a fixed structure.

2. The system of claim 1, wherein each field transmitter broadcasts an encoded signal at a different radio frequency.

3. The system of claim 2, wherein each hazard or warning is associated with a different radio frequency.

4. The system of claim 2, wherein the receiver determines the imminent corresponding hazard or warning based on the radio frequency of the encoded signal.

5. The system of claim 1, wherein each field transmitter is located at a location of the hazard or the warning.

6. The system of claim 1, wherein the hazard or warning is at least one from the group comprising low bridge, school zone, a road crew, stop sign, new traffic pattern, traffic accident, road construction.

7. The system of claim 1, wherein each field transmitter is mounted on at least one item from the group comprising a bridge, a road construction site, a road sign, a tow truck, a post stuck in the ground, a controlled access point.

8. The system of claim 1, wherein the housing unit is mounted inside the vehicle.

9. A vehicle proximity alert device comprising:
an antenna for receiving an encoded signal from a plurality of field transmitters, wherein each encoded signal includes identification information for determining an imminent corresponding road hazard or road warning;
a receiver for decoding the encoded signal and determining the imminent corresponding road hazard or road warning associated with the encoded signal;
a vehicle interface unit for communicating the corresponding road hazard or road warning to the operator of the vehicle; and
a housing unit which encloses the antenna, receiver and vehicle interface unit, the housing unit including a solar panel for providing power to the antenna, receiver and vehicle interface unit, and one or more apertures for mounting the housing unit on a fixed structure.

10. The device of claim 9, wherein each field transmitter broadcasts an encoded signal at a different radio frequency.

11. The device of claim 10, wherein each road hazard or road warning is associated with a different radio frequency.

12. The device of claim 10, wherein the receiver determines the imminent corresponding road hazard or road warning based on the radio frequency of the encoded signal.

13. The device of claim 9, wherein each field transmitter is located at a location of the road hazard or the road warning.

14. The device of claim 9, wherein the road hazard or road warning is at least one from the group comprising low bridge, school zone, road crew, stop sign, new traffic pattern, traffic accident, and road construction.

15. The device of claim 9, wherein each field transmitter is mounted on at least one item from the group comprising a bridge, a road construction site, a road sign, a tow truck, a post stuck in the ground, a controlled access point.

16. The device of claim 9, wherein the housing unit is mounted inside the vehicle.
